(19) United States
(12) Patent Application Publication
(10) Pub. No.: US 2020/0083963 A1
(43) Pub. Date: Mar. 12, 2020

(54) TRANSIT DEVICE AND COMMUNICATION SYSTEM

(71) Applicant: FANUC CORPORATION, Yamanashi (JP)

(72) Inventor: Hisashi MOMOTANI, Yamanashi (JP)

(21) Appl. No.: 16/554,622

(22) Filed: Aug. 29, 2019

(30) Foreign Application Priority Data
Sep. 12, 2018 (JP) 2018-170774

(51) Int. Cl. H04B 15/00; H01F 38/14

(52) U.S. Cl. CPC H04B 15/005; B25J 9/161; H01F 38/14

(57) ABSTRACT

A transit device that can suppress deterioration of a waveform of a transmitted signal and suppress noise superimposed on the signal while securing a required insulation distance is provided. The transit device is connected to a communication line connecting a first communication device and a second communication device and includes pulse transformers serially connected in the communication line, at least one first pulse transformer of the pulse transformers including an insulation transformer for insulating the first communication device from the second communication device and a common-mode transformer serially connected with the insulation transformer in the communication line for attenuating noise superimposed on the signal transmitted through the communication line, a second pulse transformer of the pulse transformers including an insulation transformer for insulating the first communication device from the second communication device.

### FIELD

The present invention relates to, for example, a transit device for relaying communication and a communication system including such a transit device.

### BACKGROUND

When a device is used in a compartment having an explosive atmosphere, an insulation distance in accordance with the explosive atmosphere must be secured for a communication line between the device installed in the compartment having the explosive atmosphere and a device installed outside the compartment having the explosive atmosphere. In view of this, a transit device including a transformer having a separation distance prescribed for a predetermined voltage is proposed (see, for example, Japanese Unexamined Patent Publication (Kokai) No. 2017-204849). In addition, an overvoltage protection circuit including a plurality of pulse transformers that are inserted into a signal line leading to each. Ethernet port of a communication device and are connected in series is proposed (see, for example, Japanese Unexamined Patent Publication (Kokai) No. 2013-219565).

### SUMMARY

Even when a plurality of pulse transformers are used to secure an insulation distance as in the technique described above, it is preferable that deterioration of a signal waveform is suppressed in order to accurately transmit the signal. In addition, it is preferable that noise to be superimposed on the transmitted signal is suppressed.

In one aspect, an object of the present invention is to provide a transit device that can secure a required insulation distance, suppress, deterioration of a waveform of a transmitted signal and suppress noise to be superimposed on the transmitted signal.

According to one embodiment, a transit device is provided. The transit device is connected to a communication line that connects a first communication device and a second communication device and includes a plurality of pulse transformers connected in series in the communication line, wherein at least one first pulse transformer of the plurality of pulse transformers includes a first insulation transformer provided for insulating the first communication device from the second communication device and a common-mode transformer which is connected in series with the first insulation transformer in the communication line and attenuates noise to be superimposed on the signal transmitted through the communication line, and wherein a second pulse transformer of the plurality of pulse transformers, which is a pulse transformer other than the first pulse transformer,includes a second insulation transformer provided for insulating the first communication device from the second communication device.

According to another embodiment, a communication system is provided The communication system includes a first communication device installed in a compartment having an explosive atmosphere, a second communication device installed outside the compartment having the explosive atmosphere, and a transit device connected to a communication line that connects the first communication device and the second communication device. The transit device includes a plurality of pulse transformers connected in series in the communication line, wherein at least one first pulse transformer of the plurality of pulse transformers includes a first insulation transformer provided for insulating the first communication device from the second communication device and a common-mode transformer which is connected in series with the first insulation transformer in the communication line and attenuates noise to be superimposed on the signal transmitted through the communication line, and wherein a second pulse transformer of the plurality of pulse transformers, which is a pulse transformer other than the first pulse transformer, includes a second insulation transformer provided for insulating the first communication device from the second communication device.

In one aspect, a transit device can secure a required insulation distance, suppress deterioration of a waveform of a transmitted signal and suppress noise to be superimposed on the transmitted signal.

### BRIEF DESCRIPTION OF DRAWINGS

FIG. 1 is a schematic configuration diagram of a robotic system including a transit device according to one embodiment.

FIG. 2 is a schematic configuration diagram of a transit device according to one embodiment.

### DESCRIPTION OF EMBODIMENTS

With reference to the drawings, a transit device will be described below. The transit device is provided on a communication line that connects a first communication device installed in a compartment having an explosive atmosphere and a second communication device installed outside the compartment having the explosive atmosphere, and includes a plurality of pulse transformers connected in series in the communication line in order to secure an insulation distance required between the first communication device and the second communication device. At least one of the plurality of pulse transformers includes an insulation transformer provided for insulating the first communication device from the second communication device and a common-mode transformer which is connected in series with the insulation transformer in the communication line and attenuates noise to be super imposed on a signal transmitted through the communication line. On the other hand, other pulse transformers of the plurality of pulse transformers include the insulation transformer provided for insulating the first communication device from the second communication device but do not include the common-mode transformer. Because of this configuration, the transit device can secure the insulation distance required between the first communication device and the second communication device and remove noise to be superimposed on the signal transmitted through the communication line by including one or more common-mode transformers in any one or more of the pulse transformers. In addition, the transit device can suppress deterioration of a waveform of the signal, caused by passing through the common-mode transformers by decreasing the number of common-mode transformers less than the number of the pulse transformers.

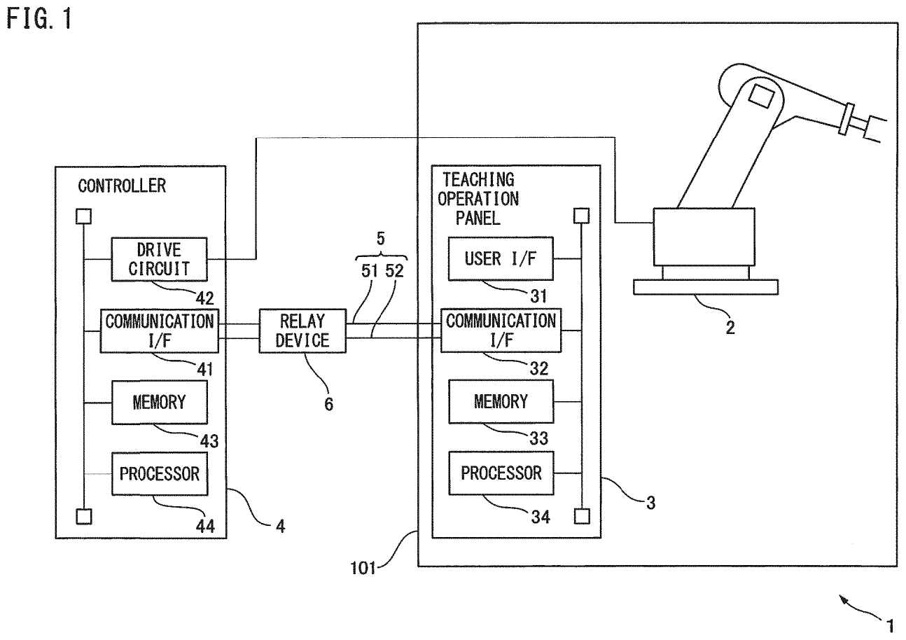

FIG. 1 is a schematic configuration diagram of a robotic system 1 including a transit device according to one embodiment. The robotic system 1 is an example of a communication system, and includes a robot 2, a teaching control device 3 for specifying an operation of the robot 2, a controller 4 for controlling the robot 2, a communication line 5 that communicatively connects the teaching control device 3 and the controller 4, and a transit device 6 connected to the communication line 5. The robot 2 and the teaching control device 3 are installed in a compartment. 101 having an explosive atmosphere. In contrast, the controller 4 and the transit device 6 are installed outside the compartment 101. Note that the controller 4 and the transit device 6 may be separately installed, or may be installed inside the same enclosure. The teaching control device 3 is an example of the first communication device installed in a compartment having an explosive atmosphere, and the controller 4 is an example of the second communication device installed outside the compartment having the explosive atmosphere.

The robot 2 is a robot including at least one shaft, and each of the at least one shaft supports a movable member such as an arm. Each movable member moves when a servomotor (not illustrated) drives a shaft by which the movable member is supported.

The teaching control device 3 specifies the operation of the robot 2 by way of an operation of teaching the robot 2. For this purpose, the teaching control device 3 includes, for example, a user interface 31, a communication interface 32, a memory 33, and a processor 34.

The user interface 31 includes, for example, a touch screen. The user interface 31 receives a series of images and the like related to the operation of teaching from the processor 34 and displays them. The user interface 31 generates an operation signal in accordance with an operation by a user such as an operation signal which is related to a movement of the robot 2 and indicates, for example, a destination position and a moving speed of the movable member included in the robot 2 and the like, and outputs the operation signal to the processor 34. Note that the user interface 31 may separately include an input device such as a keyboard or a mouse for inputting the operation signal and a display device such as a liquid crystal display. The user interface 31 may have an operation button for stopping the robot 2 in operation.

The communication interface 32 includes, for example, a communication interface for connecting the teaching control device 3 to a communication line 5 and a circuit for executing a process of transmitting/receiving a signal via the communication line 5, and the like. Furthermore, the communication interface 32 may include an insulation transformer (not illustrated) for insulating the communication line 5 from a signal line inside the teaching control device 3. Every time the communication interface 32 receives a signal containing a series of images related to the operation of teaching (e.g. the series of images representing change in a posture of the robot 2 in the specified operation) to be displayed on the user interface 31, from the controller 4 via the communication line 5, the communication interface 32 passes the received signal to the processor 34. In addition, the communication interface 32, outputs a signal received from the processor 34 and containing an operation specification information for specifying the operation of the robot 2 to the controller 4 via the communication line 5.

The memory 33 includes, for example, a readable/writable semiconductor memory and a read-only semiconductor memory. The memory 33 stores various types of computer programs which are executed by the processor 34 of the teaching control device 3 and executing a process related to the operation of teaching the robot 2 and the series of images to be displayed on the user interface 31 in the operation of teaching, which images have been received from the controller 4. In addition, the memory 33 stores various types of data and the like generated in the process related to the operation of teaching.

The processor 34 includes, for example, a Central Processing Unit (CPU) and a peripheral circuit thereof. The processor 34 may further include a processor for numeric operations. The processor 34 executes the process related to the operation of teaching the robot 2 in accordance with the computer programs loaded from the memory 33. In the process, the processor 34 saves the series of images related to the operation of teaching, which have been received from the controller 4 via the communication line 5 and the communication interface 32, in the memory 33. Then, the processor 34 loads the series of images from the memory 33 in accordance with progress of the process related to the operation of teaching, and displays the series of images on the user interface 31. In addition, the processor 34 generates, on the basis of the operation signal received from the user interface 31, a signal containing the operation specification information, and transmits the signal to the controller 4 via the communication interface 32 and the communication line 5.

Note that the memory 33 and the processor 34 may be omitted in the teaching control device 3. In this case, the operation signal input from the user interface 31 is directly transmitted to the controller 4 via the communication interface 32. The series of images received from the controller 4 via the communication interface 32 may be displayed on the user interface 31 in order of reception.

The controller 4 is connected with the teaching control device 3 via the communication line 5. The controller 4 transmits the series of images related to the operation of teaching to the teaching control device 3 via the communication line 5. In addition, the controller 4 retrieves the operation specification information from the signal received from the teaching control device 3 via the communication line 5 and containing the operation specification information, and stores the operation specification information. Furthermore, the controller 4 is connected with the robot 2 via a signal line and the like, and outputs, in accordance with the operation specification information, a drive signal to a servomotor that drives a shaft provided for each joint of the robot 2, to control a position and a posture of the robot 2.

For this purpose, the controller 4 includes communication interface 41, a drive circuit 42, a memory 43, and a processor 44. The controller 4 may further include a user interface such as a touch screen.

The communication interface 41 includes, for example, a communication interface for connecting the controller 4 to the communication line 5, a circuit for executing a process of transmitting/receiving a signal via the communication line 5, and the like. Furthermore, the communication interface 41 may include an insulation transformer (not illustrated) for insulating the communication line 5 from the signal line inside the controller 4. The communication interface 41 transmits, for example, the signal received from the processor 44 and containing the series of images related to the operation of teaching to the teaching control device 3 via the communication line 5. In addition, the communication interface 41 passes the signal received from the teaching control device 3 via the communication line 5 and containing the operation specification information to the processor 44.

The drive circuit 42 generates a drive signal in response to a torque, a direct on of rotation, or a rotation speed to be generated by each servomotor included in the robot 2 in accordance with the control by the processor 44, and outputs the generated drive signal to the robot 2.

The memory 43 includes, for example, a readable/writable semiconductor memory and a read-only semiconductor memory. The memory 43 may further include a storage medium such as a semiconductor memory card, a hard disk, or an optical storage medium and a device for accessing the storage medium.

The memory 43 stores various types of computer programs for controlling the robot 2, which are executed by the processor 44 of the controller 4, and various types of data used for controlling the robot 2 such as the operation specification information in addition, the memory 43 stores the series of images related to the operation of teaching the robot 2.

The processor 44 includes, for example, a Central Processing Unit (CPU) and a peripheral circuit thereof. The processor 44 controls the entire robotic system 1. In addition, the processor 44 executes the process related to the operation of teaching the robot 2.

While the process related to the operation of teaching the robot 2 is executed, the processor 44 loads the series of images stored in the memory 43 and transmits the series of images to the teaching control device 3 via the communication interface 41 and the communication line 5. In addition, when the processor 44 receives the signal containing the operation specification information from the teaching control device 3 via the communication line 5 and the communication interface 41, the processor 44 retrieves the operation specification information from the signal and saves the operation specification information in the memory 43. Furthermore, when the processor 44 operates the robot 2, the processor 44 loads the operation specification information stored in the memory 43, controls the drive circuit 42 in accordance with the operation specification information, and causes the drive circuit 42 to generate a drive signal for the robot 2 to implement the operation specified in the operation specification information.

The communication line 5 is a communication line utilized for communication between the teaching control device 3 and the controller 4 and compliant with a predetermined communication standard such as the Ethernet (a registered trademark), and the communication line 5 may be, for example, a twisted-pair cable. In the present embodiment, the communication line 5 includes a first pair of signal lines 51 that is utilized for signal transmission from the teaching control device 3 to the controller 4 and in which a signal is transmitted in accordance with differential transmission method and a second pair of signal lines 52 that is utilized for signal transmission from the controller 4 to the teaching control device 3 and in which a signal is transmitted in accordance with differential transmission method.

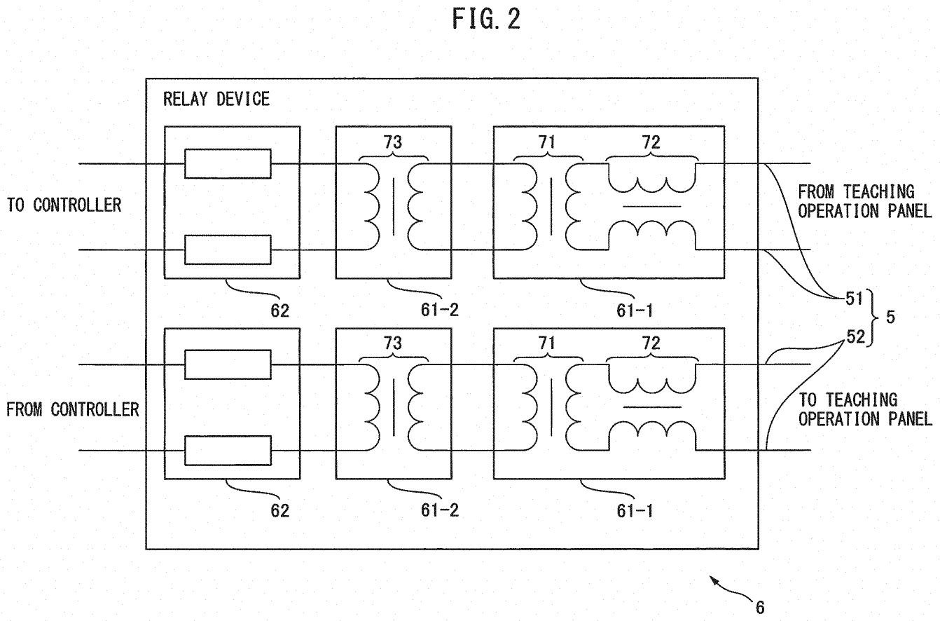

FIG. 2 is a schematic configuration diagram of the transit device 6 according to one embodiment. The transit device 6 is provided in the middle of the communication line 5, relays transmission of signals between the teaching control device 3 and the controller 4 in the communication line 5, and Insulates the teaching control device 3 from the controller 4. For this purpose, the transit device 6 includes, in each of the first pair of signal lines 51 and the second pair of signal lines 52, a plurality of pulse transformers 61-1 to 61-n (n is an integer of two or more) connected in series and an overvoltage protection circuits 62. Note that, in the present embodiment, the transit device 6 Includes, in each of the first pair of signal lines 51 and the second pair of signal lines 52, two pulse transformers (i.e., n=2).

Each of the pulse transformers and the overvoltage protection circuit 62 included in the first pair of signal lines 51 may have the same configurations and the same functions as each of the pulse transformers and the overvoltage protection circuit 62 included in the second pair of signal lines 52. Therefore, description is made below with regard to each of the pulse transformers and the overvoltage protection circuit 62 included in the first pair of signal lines 51.

Among the plurality of pulse transformers 61-1 to 61-n, the pulse transformer 61-1 connected to the side closest to the teaching control device 3, i.e., the side closest to the compartment. 101 having the explosive atmosphere, is an example of the first pulse transformers, and the pulse transformer 61-1 Includes an insulation transformer 71 and a common-mode transformer 72, which are connected in series with each other in the first pair of signal lines 51.

The insulation transformer 71 insulates the teaching control device 3 from the controller 4 in the first pair of signal lines 51. For this purpose, the insulation transformer 71 may be any one of various types of insulation transformers used for signal transmission.

The common-mode transformer 72 attenuates noise, which is a frequency component contained in a signal transmitted through the first pair of signal lines 51 and having a frequency higher than a predetermined cutoff frequency, as a measure for Electro Magnetic Compatibility (EMC). For this purpose, the common-mode transformer 72 may be any one of various types of common mode transformers used for signal transmission.

When the transit device 6 is provided between the teaching control device 3 installed in the compartment having the explosive atmosphere and the controller 4 installed outside the compartment in order to secure an insulation distance as in the present embodiment, the transit device 6 itself is installed outside the compartment having the explosive atmosphere. Therefore, the length of the communication line between the transit device 6 and the teaching control device 3 is longer than the length of the communication line between the transit device 6 and the controller 4. Therefore, the communication line between the transit device 6 and the teaching control device 3 is more easily affected by noise than the communication line between the transit device 6 and the controller 4. Consequently, by including a common-mode transformer in the pulse transformer closest to the teaching control device 3, the transit device 6 can effectively remove noise.

Among the plurality of pulse transformers 61-1 to 61-n, pulse transformers other than the pulse transformer 61-1 (in the present embodiment, the pulse transformer 61-2, which is an example of the second pulse transformer) include an insulation transformer 73 connected to the first pair of signal lines 51. However, the pulse transformers other than the pulse transformer 61-1 do not include a common-mode transformer. Therefore, in the pulse transformer 61-2, the waveform of the signal is not affected by deterioration caused by passing through the common-mode transformer. Thus, the transit device 6 as a whole suppresses deterioration of the waveform of the transmitted signal.

The insulation transformer 73 insulates the teaching control device 3 from the controller 4 in the first pair of signal lines 51. For this purpose, the insulation transformer 73 may be any one of various types of insulation transformers used for signal transmission.

The number of the pulse transformers included in the transit device 6 and connected in series in the first pair of signal lines 51 may be determined in such a way that the sum of insulation distances given by the insulation transformers included in the pulse transformers Is greater than the insulation distance required between the teaching control device 3 and the controller 4. When at least one of the communication interface 32 of the teaching control device 3 and the communication interface 41 of the controller 4 includes an insulation transformer, the number of the pulse transformers connected in series in the first pair of signal line 51 may be determined in such a way that the sum of insulation distances given by the Insulation transformer(s) included in the communication interface 32 of the teaching control device 3 and the insulation transformer(s) included in the communication interface 41 of the controller 4 and the insulation distances given by insulation transformers included in the pulse transformers, included in the transit device 6 and connected in series in the first pair of signal lines 51, is greater than the insulation distance required between the teaching control device 3 and the controller 4.

The overvoltage protection circuit 62 is connected in series with the plurality of pulse transformer 61-1 to 61-n between the teaching control device 3 and the controller 4 in the first pair of signal lines 51. In the present embodiment, the overvoltage protection circuit 62 is connected between the controller 4 and the pulse transformer 61-2 provided on the side closest to the controller 4 of the plurality of pulse transformers 61-1 and 61-2. However, the overvoltage protection circuit 62 may be connected between the pulse transformers 61-1 and 61-2 or between the pulse transformer 61-1 and the teaching control device 3.

When a voltage equal to or higher than a predetermined voltage which is higher than a voltage usually applied in signal transmission, is applied to the first pair of signal lines 51, the overvoltage protection circuit 62 suppresses the voltage from being applied to the teaching control device 3. For this purpose, the overvoltage protection circuit 62 includes, for example, a fuse and opens the first pair of signal lines 51 when a voltage equal to or higher than the predetermined voltage is applied to the first pair of signal lines 51. Alternatively, the overvoltage protection circuit 62 may be any one of various other types of overvoltage protection circuits such as a thyristor. Note that, the overvoltage protection circuit 62 may be a circuit that prevents a current from flowing through the first pair of signal lines 51, when the current which flows through the first pair of signal lines 51 is equal to or higher than a predetermined current which is higher than a current that usually flows in signal transmission. In addition, when the communication interface 41 of the controller 4 includes an overvoltage protection circuit, the overvoltage protection circuit 62 may be omitted.

As described above, the transit device includes the plurality of pulse transformers connected in series in the communication line between the first communication device installed in the compartment having the explosive atmosphere and the second communication device installed outside the compartment having the explosive atmosphere. Therefore, the transit device can secure the insulation distance required between the first communication device and the second communication device. In addition, the transit device can remove noise to be superimposed on the signal transmitted through the communication line by including one or more common-mode transformers in at least one of the plurality of pulse transformers and suppress deterioration of the waveform of the signal, caused by passing through the common-mode transformers by decreasing the number of the common-mode transformers less than the number of the pulse transformers. Further, the transit device can secure the insulation distance without including a component that limits transmission rate of the signal such as a photo coupler, and therefore, the transmission rate of the signal between the first communication device and the second communication device need not be lowered. Therefore, as in the embodiment described above, even if large volumes of data such as a series of images are transmitted, the transit device can prevent latency due to data transmission from increasing.

Note that, according to a variation, as the communication line between the first communication device installed in the compartment having the explosive atmosphere and the second communication device installed outside the compartment, a transmission medium used for a communication line other than the twisted-pair cable may be used, for example, a coaxial cable. In this case also, the pulse transformers of the transit device may be connected in series with each other in the transmission medium.

According to another variation, the transit device may include a plurality of pulse transformers that include a common-mode transformer. In this case, the number of pulse transformers including a common-mode transformer may be determined based on a length of the communication line between the transit device and the first communication device installed in the compartment having the explosive atmosphere or based on a maximum permissible level for the noise to be superimposed on the transmitted signal. For example, as the length of the communication line between the transit device and the first communication device installed in the compartment having the explosive atmosphere is longer, or as the maximum permissible level for the noise to be superimposed on the transmitted signal is lower, the number of the pulse transformers including the common-mode transformer may be increased.

Furthermore, when the length of the communication line between the transit device and the first communication device installed in the compartment having the explosive atmosphere is equal to or shorter than the length of the communication line between the transit device and the second communication device installed outside the compartment having the explosive atmosphere, the pulse transformers may be arranged in such a way that the pulse transformers including a common-mode transformer of the plurality of pulse transformers are closest to the second communication device installed outside the compartment having the explosive atmosphere.

Furthermore, the first communication device installed in the compartment having the explosive atmosphere is not limited to the teaching control device. For example, when the robot installed in the compartment having the explosive atmosphere is connected with the controller via the communication line, the robot may be another example of the first communication device. Similarly, the second communication device installed outside the compartment having the explosive atmosphere is not limited to the controller of the robot. For example, when the teaching control device is installed outside the compartment having the explosive atmosphere and the teaching control device is connected with the robot installed in the compartment having the explosive atmosphere via the communication line, the teaching control device may be another example of the second communication device. Furthermore, the first communication device and the second communication device may be included in a communication system other than robotic system In this case also, the first communication device may be a device installed in the compartment having the explosive atmosphere, and the second communication device may be a device installed outside the compartment having the explosive atmosphere.

All examples and specific terms used herein are intended for an instructive purpose to facilitate readers to understand the present invention and a concept contributed by the inventor of the present invention for promoting the technique, and should not be construed as being limited to such specific examples and conditions described herein and any configurations in such examples, which are related to describing superiority and inferiority of the present invention. Although the embodiments of the present invention have been described in detail, it should be understood that various changes, substitutions, and alterations may be made without departing from the spirit and scope of the present invention.

What is claimed is:

1. A transit device connected to a communication line that connects a first communication device and a second communication device, comprising:
a plurality of pulse transformers connected in series in the communication line,
wherein at least one first pulse transformer of the plurality of pulse transformers includes a first insulation transformer provided for insulating the first communication device from the second communication device and a common-mode transformer which is connected in series with the first insulation transformer in the communication line and attenuates noise to be superimposed on a signal transmitted through the communication line, and wherein a second pulse transformer of the plurality of pulse transformers, which is a pulse transformer other than the first pulse transformer, include s a second insulation transformer provided for insulating the first communication device from the second communication device.

2. The transit device according to claim. 1, wherein the communication line between the first communication device and the transit device is longer than the communication line between the second communication device and the transit device, and wherein the first pulse transformer is provided in the communication line closer to the first communication device than the second pulse transformer.

3. A communication system, comprising:
a first communication device installed in a compartment having an explosive atmosphere;
a second communication device installed outside the compartment having the explosive atmosphere; and
a transit device connected to a communication line that connects the first communication device and the second communication device,
wherein the transit device comprises a plurality of pulse transformers connected in series in the communication line, and
wherein at least one first pulse transformer of the plurality of pulse transformers includes a first insulation transformer provided for insulating the first communication device from the second communication device and a common-mode transformer which is connected in series with the first insulation transformer in the communication line and attenuates noise to be superimposed on a signal transmitted through the communication line, and wherein a second pulse transformer of the plurality of pulse transformers, which is a pulse transformer other than the first pulse transformer, includes a second insulation transformer provided for insulating the first communication device from the second communication device.
